(19) United States
(12) Patent Application Publication
(10) Pub. No.: US 2016/0280810 A1
(43) Pub. Date: Sep. 29, 2016

(54) Method to Fabricate Polyolefin Polymer with Hydroxyl Functional Group

(71) Applicant: Lee Chang Yung Chemical Industry Corporation, Kaohsiung City (TW)

(72) Inventors: Ping-Wen WANG, Kaohsiung City (TW); Ching-Chung KUO, Kaohsiung City (TW)

(21) Appl. No.: 14/671,971

(22) Filed: Mar. 27, 2015

(51) Int. Cl. C08F 8/12

(52) U.S. Cl. CPC C08F 8/12

(57) ABSTRACT

A method to fabricate polyolefin polymer with hydroxyl functional group is taught. The method comprises following steps: (1) blending a polar solvent, an α,ω-alkyenol compound and a trialkyl halosilane compound to form an trialkyl-siloxane group protected co-monomer; (2) copolymerizing the trialkyl-siloxane group protected co-monomer with an α-olefin monomer to form a copolymer with side chain trialkyl-siloxane group protectors in presence of a metallocene catalyst and co-catalyst mixture; and (3) hydrolyzing the copolymer with an acid to form the polyolefin polymer with at least one hydroxyl functional group.

### BACKGROUND OF THE INVENTION

1. Field of the Invention

The present invention relates to polyolefin polymer, and in particular relates to fabricating methods of polyolefin polymer with hydroxyl functional group.

2. Description of the Related Art

Ethylene-α-olefin copolymers such as ethylene-propylene copolymer and ethylene-propylene-nonconjugated diene terpolymer are good in properties, such as moldability, mechanical strength, water resistance, weatherability, heat resistance and chemical resistance. These polymers have been widely used in many fields, including: car components, home electric appliances, office equipment and paints, etc. However, the molecules of ethylene-α-olefin copolymers carry no polar functional groups. Without such polar functional groups in the molecules may result in less satisfactory coatability and adhesiveness with other substances.

Traditionally, in order to introduce functional groups into polyolefin, peroxides and azo initiators usually requires a considerable amount of thermal input to decompose the material and thereby to generate free radicals. However, high temperature processing often causes significant reduction in molecular weight of the polymer and some important properties of the polymer such as coatability or adhesiveness may be lost.

U.S. Pat. No. 5,939,495 disclosed a process for producing a polyolefin having a functional group at its terminal, which was done via an in situ chain transfer reaction. The polyolefin obtained in such way can be used as a compatibilizer for polymer blending, or it can also be used as a starting material in molecular designing. However, only having a functional group formed at its terminal which limits numbers of functional groups to be attached in the backbone, the resulting performance of the polyolefin is not desirable.

U.S. Pat. No. 6,015,862 disclosed functionalized terpolymers of two different α-olefin and para-alkylstyrene, wherein the functionalized terpolymers have a substantially homogeneous compositional distribution. The functional polymer having graft copolymer structure can be prepared from the mixed α-olefin/p-alkylstyrene terpolymers under mild reaction conditions. Graft-from and graft-onto reactions can be applied to produce polyolefin graft copolymers which have polyolefin backbone and several polymer chains (as the side chains) randomly bonded to the polyolefin backbone.

U.S. Pat. No. 6,479,600 disclosed a functional polyolefin material containing a terminal styrene or styrene derivative unit. Its major objective is to prepare polyolefin having a terminal functional group that can serve as a reactive site for coupling reactions or as an initiator for polymerization processes that produce polyolefin diblock copolymers. Some of the protected functional end groups, such as COOR, O—SiR₃ and N(SiR₃)₂, used during the polymerization can be de-protected by HCl to recover COOH, OH and NH₂ terminal group, respectively.

Paavola et al., European Polymer Journal, vol 41, pp. 2861-2866 (2005) stated that propylene was copolymerized with 10-undecen-1-ol with use of dimethylsilanyl-bis-(2-methyl-4-phenyl-1-indenyl)zirconium dichloride as catalyst activated with methylaluminoxane (MAO) and triisobutylaluminum (TIBA). Comonomer incorporations as high as 2.0 mol % or 8.2 wt % were obtained without serious activity losses. It was possible to polymerize functional polypropylene by adjusting the proportion of MAO in the mixture of MAO and TIBA used as cocatalyst. However, the polymerization activity, functionality content and molecular weight may be compromised.

Another method proposed by Yuan et al. to produce hydroxyl-modified copolymers by copolymerizating propylene with various comonomers via both homogeneous and heterogeneous isospecific Ziegler-Natta catalysts. Both borane and silane functional groups were known to be stable in Ziegler-Natta catalysis systems, and the resulting borane- and silane-containing PP(propylene) copolymers were further interconverted into the corresponding OH containing polymers. The high molecular weight, characteristically tapered PP—OH copolymer prepared by the heterogeneous Ziegler-Natta catalyst shows high crystallinity with a unique network structure, via interchain OH groups dimerization (H-bonding), offering not only higher polarizability but also good reversibility. However, the OH group content cited here could only reach 4.2 mol % in the copolymers, such activity of the PP—OH reaction is far too low to be adopted by the industry.

The method described by Gupta et al., is able to produce PP—OH (hydroxyl-modified polypropylenes) with side chains containing OH groups. It was done by copolymerizating the propylene and undecenyloxytrimethylsilane monomers using Ziegler-Natta catalyst. Copolymers with hydroxyl concentration up to 4 mol % were produced. Again, the activity of the PP—OH reaction is also too low to satisfy industrial demands.

In summary, direct polymerization of polar comonomers using Ziegler-Natta catalysts has its process limitations, for example, it may lead to catalyst deactivation, polymer degradation, and comonomer homopolymerization. Besides, the copolymerization of styrene and α-olefins is usually difficult in the direct copolymerization processes using Ziegler-Natta catalysts. Normally, only few percent of styrene can be randomly incorporated in polyethylene (HDPE) and isotactic polypropylene (i-PP) in batch reactions.

In addition, some prior arts can only render the functional group being attached at the end of copolymer which restricts the amount of the functional groups. The copolymer having restricted functional groups may induce poor affinity with other substances. On the other hand, though some prior arts can only achieve about 4 mol % hydroxyl concentration, such level is not sufficient to reach industrial requirements. Therefore, it is necessary to find a better solution which can be adopted by the industry with a higher commercial value.

### BRIEF SUMMARY OF THE INVENTION

The invention is directed to a method to fabricate polyolefin polymer with a plurality of hydroxyl functional groups.

According to an aspect of the present disclosure, a method to fabricate polyolefin polymer with hydroxyl functional group is provided. The method comprises following steps: (1) blending a polar solvent, an α,ω-alkyenol compound and a trialkyl halosilane compound to form an trialkyl-siloxane group protected co-monomer; (2) copolymerizing the trialkyl-siloxane group protected co-monomer with an α-olefin monomer to form a copolymer with side chain trialkyl-siloxane group protectors in presence of a metallocene catalyst and co-catalyst mixture and (3) hydrolyzing the copolymer with an acid to form the polyolefin polymer with hydroxyl functional groups.

According to another aspect of the present disclosure, a method to fabricate polyolefin polymer with hydroxyl functional group is provided. The method comprises following steps: (1) blending a polar solvent, an α,ω-alkyenol compound and a dialkyl dihalosilane compound to form an dialkyl-siloxane group protected co-monomer; (2) copolymerizing the dialkyl-siloxane group protected co-monomer with an α-olefin monomer to form a copolymer with side chain dialkyl-siloxane group protectors in presence of a metallocene catalyst and co-catalyst mixture and (3) hydrolyzing the copolymer with an acid to form the polyolefin polymer with hydroxyl functional groups.

The above and other aspects of the disclosure will become better understood with regard to the following detailed description of the preferred but non-limiting embodiment(s).

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

A method to fabricate polyolefin polymer with hydroxyl functional group is provided. The method comprises the following steps—blending, copolymerizing and hydrolyzing steps. First, blending a polar solvent, an α,ω-alkyenol compound and an alkyl halosilane compound to form an alkyl-siloxane group protected co-monomer. Then, copolymerizing the alkyl-siloxane group protected co-monomer with an α-olefin monomer to form a copolymer with side chain alkyl-siloxane group protectors in presence of a metallocene catalyst and co-catalyst mixture. Finally, hydrolyzing the copolymer with an acid to form the polyolefin polymer with hydroxyl functional group.

For the blending step, the polar solvent, the α,ω-alkyenol compound and the alkyl halosilane compound are provided to form an alkyl-siloxane group protected co-monomer. In one embodiment, the α,ω-alkyenol compound may be presented in formula [I]:

CH₂═CH-L-OH [I]

wherein L is alkyl comprising a carbon number from about 1 to about 20 and may be selected from the group consisting of linear, branched and cyclic alkyl. In another embodiment, the α,ω-alkyenol compound may be presented in formula [II]:

CH₂═CHCH₂)ₚ—OH [II]

wherein p is an integer between about 1 and about 20. Alternatively, p is an integer between about 5 and about 11. For example, the α,ω-alkyenol compound may be selected from the group consisting of 2-propen-1-ol, 3-buten-1-ol, 4-penten-1-ol, 5-haxen-1-ol, 6-hepten-1-ol, 7-octen-1-ol, 8-nonen-1-ol, 9-decen-1-ol, 10-undecen-1-ol, 17-octadecan-1-ol and a combination thereof.

In one embodiment, the alkyl halosilane compound may be trialkyl halosilane compound. The trialkyl halosilane compound is shown below.

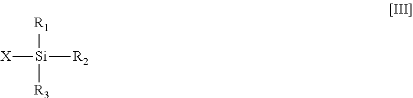

In this formula each of the R₁, R₂ and R₃ is the same or different alkyl group comprising a carbon number from about 1 to about 20 and X is selected from the group consisting of fluorine, chlorine, bromine, iodine and a combination thereof. In another embodiment, one of the R₁, R₂ and R₃ is alkyl group comprising a carbon number greater than 2, and two of the R₁, R₂ and R₃ are methyl groups. For example, the trialkyl halosilane compound could be selected from the group consisting of a tert-butyldimethylchlorosilane, an iso-butyldimethylchlorosilane, an n-butyldimethylchlorosilane and a combination thereof.

In another embodiment, the alkyl halosilane compound may be dialkyl dihalosilane compound. The dialkyl dihalosilane compound is presented as below.

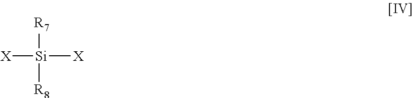

In this formula each of the R₇ and R₈ is the same or different alkyl group comprising a carbon number from about 1 to about 20. X is selected from the group consisting of fluorine, chlorine, bromine, iodine and a combination thereof.

The α,ω-alkyenol compound and the alkyl halosilane compound may be added into the polar solvent together or separately. The polar solvent may be selected from the group consisting of tetrahydrofuran (THF), diethylether and a combination thereof. After the α,ω-alkyenol compound and the alkyl halosilane compound react in the polar solvent, the alkyl-siloxane group protected co-monomer is produced. In one embodiment, the alkyl-siloxane group protected co-monomer may be trialkyl-siloxane group protected co-monomer. The trialkyl-siloxane group protected co-monomer is presented as the following formula [V]:

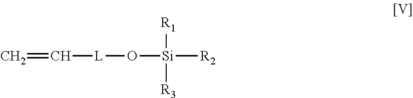

wherein each of the R₁, R₂ and R₃ is the same or different alkyl group comprising a carbon number from about 1 to about 20 and wherein L is alkyl comprising a carbon number from about 1 to about 20 and may be selected from the group consisting of linear, branched and cyclic alkyl. The trialkyl-siloxane group may act as steric hindrance to enhance the copolymerization activity. In another embodiment, the alkyl-siloxane group protected co-monomer may be dialkyl-siloxane group protected co-monomer. The dialkyl-siloxane group protected co-monomer is presented in the following formula [VI]:

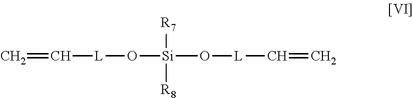

wherein each of the R₇ and R₈ is the same or different alkyl group comprising a carbon number from about 1 to about 20. L is alkyl comprising a carbon number from about 1 to about 20 and may be selected from the group consisting of linear, branched and cyclic alkyl. The dialkyl-siloxane group may act as steric hindrance to enhance the copolymerization activity.

In one embodiment, a trialkyl amine compound is further added during the blending step. For example, the trialkyl amine may be blended with the α,ω-alkyenol compound in the polar solvent. In one embodiment, the trialkyl amine compound may be selected from the group consisting of trimethyl amine, triethyl amine and a combination thereof. Adding the trialkyl amine compound may drive the reaction equilibrium toward the alkyl-siloxane group protected co-monomer side.

For the copolymerizing step, using the alkyl-siloxane group protected co-monomer to copolymerize an α-olefin monomer to form a copolymer with side chain alkyl-siloxane group protectors in presence of a metallocene catalyst and co-catalyst mixture. In one embodiment, the copolymerizing process may be carried out in a temperature range from about 35° C. to about 100° C. and in a pressure range from about 1 psi to about 1000 psi.

In another embodiment, the copolymerizing process may be carried out in a temperature range from about 40° C. to about 80° C. and a pressure range from about 10 psi to about 1000 psi. The copolymerizing reaction may be carried out either under a batch mode or a continuous mode in a reactor with separated inlet pipes for monomers and catalyst.

In one embodiment, the α-olefin monomer comprises about 3 to about 12 carbon atoms. The α-olefin monomer is presented as the formula [VII]:

CH₂═CHCH₂)ₙ—CH₃ [VII]

wherein n is an integer between 0 and about 9. In another embodiment, the α-olefin monomer is propylene. The α-olefin monomer may be in the form of liquid phase. For example, one may introduce liquid phase α-olefin monomer to the alkyl-siloxane group protected co-monomer to improve the activity performance, because the concentration of liquid phase α-olefin monomer is higher than that of gas phase.

In one embodiment, ethylene may be further added to react with the α-olefin monomer and trialkyl-siloxane group protected co-monomer for the copolymerizing reaction. The copolymer with side chain trialkyl-siloxane group protectors is presented as the formula [VIII]:

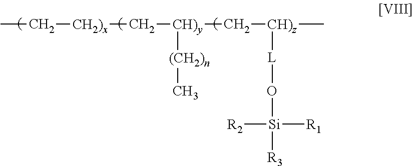

wherein n is an integer between 0 and about 9. In this formula, each of the R₁, R₂ and R₃ is the same or different alkyl group comprising a carbon number from about 1 to about 20, and L is alkyl comprising a carbon number from about 1 to about 20 and may be selected from the group consisting of linear, branched and cyclic alkyl. About the x, y and z in the formula [VIII], wherein first set total number x+y+z=sum. In one embodiment, the mole % of ethylene-derived units in the copolymer is defined as x/sum, which may be between 0% and about 20%. The mole % of α-olefin units in the copolymer, y/sum, may be between about 50% and about 99.9%. The mole % of hydroxyl functional group derived units in the copolymer, z/sum, may be between about 0.1% and about 30%. In other words, the hydroxyl functional group molar percent of the polyolefin polymer with hydroxyl functional group may be between about 0.1% and about 30%.

In another embodiment, ethylene may be further added to react with the α-olefin monomer and dialkyl-siloxane group protected co-monomer for the copolymerizing reaction. The copolymer with side chain dialkyl-siloxane group protectors is presented as formula [IX]:

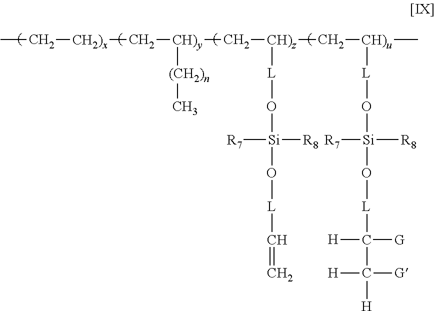

wherein G and G′, independently, are selected from the group consisting of H and polymer chain. In this formula, each of the R₇ and R₈ is the same or different alkyl group comprising a carbon number from about 1 to about 20 and n is an integer between 0 and about 9. L is alkyl comprising a carbon number from about 1 to about 20 and may be selected from the group consisting of linear, branched and cyclic alkyl. About the x, y, z and u in the formula [IX], wherein first set total number x+y+z+u=sum. In one embodiment, the mole % of ethylene-derived units in the copolymer is defined as x/sum, which may be between 0% and about 20%. The mole % of α-olefin units in the copolymer, y/sum, may be between about 50% and about 99.9%. The mole % of hydroxyl functional group derived units in the copolymer, (z+u)/sum may be between about 0.1% and about 30%. In other words, the hydroxyl functional group molar percent of the polyolefin polymer with hydroxyl functional group may be between about 0.1% and about 30%.

The copolymerizing reaction takes place in presence of the metallocene catalyst and co-catalyst mixture which may be formed by mixing metallocene catalyst with cocatalyst. The cocatalyst may be selected from the group consisting of methylaluminoxane (MAO), boron-containing activating agent and a combination thereof. In one embodiment, the boron-containing activating agent is tetrakis-pentafluorophenyl-borato-triphenylcarbenium.

In one embodiment, the metallocene catalyst is presented as formula [X]:

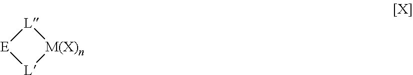

M is a transition metal selected from the group consisting of III and IV of the periodic table of the elements. L′ and L″, independently, are selected from the group consisting of cyclopentadienyl and substituted cyclopentadienyl groups bound in η5-bonding mode to the transition metal. E may be selected from the group consisting of carbon and silicon with a substituent group. The substituent group may be selected from the group consisting of hydrogen, alkyl, aryl, silyl, halogenated alkyl, halogenated aryl, and a combination thereof. X may be selected from the group consisting of hydride, halo, alkyl, aryl, aryloxy, alkoxy and a combination thereof n is 1 or 2.

In one embodiment, a scavenger may be further added for the copolymerizing step. The scavenger could be trialkylaluminum presented as formula [XI]:

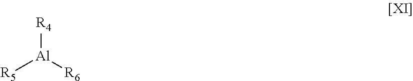

Each of R₄, R₅ and R₆ is the same or different alkyl group comprising about 1 to about 20 carbon atoms. For example, the trialkylaluminum may be selected from the group consisting of trimethylaluminum (TMA), triethylaluminum (TEA), triisobutylaluminum (TIBA), trioctylaluminum (TOA) and a combination thereof. The purpose of adding the scavenger is to cleanse the impurities, otherwise they may poison the polymerization or to deactivate the polymerized reaction. The scavenger may also act as cocatalyst to help activating metallocene catalyst.

Hydrolyzing the copolymer with an acid will form the polyolefin polymer with hydroxyl functional group. The acid may provide a proton to substitute for the alkyl siloxane group in the copolymer to form hydroxyl functional group. The polyolefin polymer may be presented as formula [XII]:

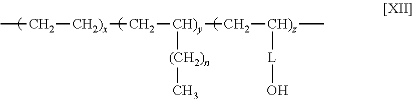

wherein L is alkyl comprising a carbon number from about 1 to about 20 and may be selected from the group consisting of linear, branched and cyclic alkyl and n is an integer between 0 and about 9. The acid may be selected form the group consisting of hydrofluoric acid, hydrochloric acid, hydrobromic acid, hydroiodic acid, sulfuric acid, nitric acid, oxalic acid, phosphoric acid and a combination thereof. More functional groups will be resulted when the hydroxyl groups are attached at the side chain of the copolymer than to the hydroxyl group are only attached at the end of the group. Typically, the resulting polyolefin polymer will be weighing and NMR, DSC and GPC analyzed to determine its polymer structure, thermal properties, molecular weight, and molecular weight distribution.

About the x, y and z in the formula [XII]:

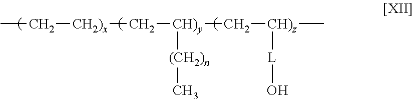

wherein first set total number x+y+z=sum. In one embodiment, the mole % of ethylene-derived units in the copolymer is defined as, x/sum, may be between 0% and about 20%. The mole % of α-olefin units in the copolymer, y/sum, may be between about 50% and about 99.9%. The mole % of hydroxyl functional group derived units in the copolymer, z/sum, may be between about 0.1% and about 30%. In other words, the hydroxyl functional group molar percent of the polyolefin polymer with hydroxyl functional group may be between about 0.1% and about 30%.

In one embodiment, the average molecular weight of the polyolefin polymer with hydroxyl functional group may be ranged from about 10,000 to about 5,000,000. In another embodiment, the average molecular weight of the polyolefin polymer with hydroxyl functional group may be ranged from about 100,000 to about 1,000,000. The alkyl-siloxane group protected co-monomer and the α-olefin monomer of the polyolefin polymer may be arranged in a random order.

Several examples are illustrative of the principles and practice of this disclosure, although not limited thereto.

Preparation 1

An one liter flask, equipped with a magnetic stirrer is used. Preparing a first solution by dissolving 69.82 g of 10-undecen-1-ol and 41.69 g of triethylamine into 350 ml of THF. Preparing a second solution by dissolving 45.71 g of chlorotrimethylsilane with 150 ml of THF. Slowly pouring both solutions into the flask at room temperature. Kept stirring the mixture at 30° C. for 18 hours. Then, the resulting white powders are filtered and removed. The resulting solution is distilled under vacuum at temperature around 110° C. to produce undecenyloxy-trimethylsilane.

Preparation 2

Similarly, an one liter flask, equipped with a magnetic stirrer is used. Dissolving 6.1 g of 10-undecen-1-ol and 4.2 g of triethylamine into 150 ml of THF to form a first solution, and then dissolving 5.47 g of tert-butyldimethylchlorosilane into 100 ml of THF to form second solution. Slowly pouring the both solutions into the flask at room temperature. Kept stirring the mixture at 30° C. for 18 hours. Then, resulting white powders are filtered and removed. The resulting solution is distilled under vacuum and the temperature at about 150° C. to produce undecenyloxy-t-butyldimethylsilane.

### Example 1

### E1

Preparing a 300 ml Parr reactor and is cleaned by using methyl alcohol. The reactor is closed tightly and heated to about 130° C. by heater at vacuum for about 30 minutes and then the vacuum and heater are removed. The Parr reactor is pressurized to about 20 psi, then, 3.0 ml TEA and 1.38 g of undecenyloxy-t-butyldimethylsilane produced by preparation 2 are added into the Parr reactor separately and kept stirring for about 10 minutes. Then, 28 g liquid propylene that stored in a bomb reservoir is introduced into the reactor by Argon gas (pressured to 244 psia) and kept stirring for another 10 minutes. Then, 0.5 mg of metallocene catalyst Rac-Me₂Si[2-Me-4-Ph(Ind)]₂ZrCl₂ with 3.5 ml cocatalyst MAO solution that stored in a tube is injected into Parr reactor by 460 psia of Argon gas at low speed of stirring to start the copolymerizing reaction. The initial temperature of the copolymerizing reaction is kept at about 60° C. and the targeted reaction temperature is maintained at about 70° C. for 60 mins. Then, HCl is added to hydrolyze the copolymer to form hydroxyl functional group by substituting the proton for the t-butyldimethylsilane group.

### Example 2

### E2

Prepared a 300 ml Parr reactor and is cleaned by using methyl alcohol. The reactor is closed tightly and heated to about 130° C. by a heater at vacuum for about 30 minutes and then the vacuum and heater are removed. The Parr reactor is pressurized to about 20 psi, then, 5 ml TIBA and 5.29 g of undecenyloxy-t-butyldimethylsilane produced by preparation 2 are added into the Parr reactor separately and kept stirring for about 10 minutes. Then, 27 g liquid propylene that stored in bomb reservoir is introduced into the reactor by Argon gas (pressured to 244 psia) and kept stirring constantly for another 10 minutes. Then, 1 mg of metallocene catalyst Rac-Me₂Si[2-Me-4-Ph(Ind)]₂ZrCl₂ with 3.5 ml cocatalyst MAO solution that stored in a tube is injected into Parr reactor by 460 psia of Argon gas at low speed of stirring to initiate the copolymerizing reaction. The initial temperature of the copolymerizing reaction is kept at about 60° C. and the targeted reaction temperature is maintained at about 70° C. for 60 mins. Then, HCl is added to hydrolyze the copolymer to form hydroxyl functional group by substituting the proton for the t-butyldimethylsilane group.

### Comparative Example 1

### CE1

Preparing a 300 ml Parr reactor and is cleaned by using toluene. The reactor is closed tightly and heated to about 130° C. by a heater under vacuum for about 30 minutes and then the heater and vacuum are removed. The pressure of the Parr reactor is released until it reaches 20 psi, then 4 ml TIBA is added into the Parr reactor. 28 g liquid propylene that stored in the bomb reservoir is introduced into the reactor by Argon gas (pressure 256 psia). Finally, 1.5 mg of metallocene catalyst Rac-Me₂Si[2-Me-4-Ph(Ind)]₂ZrCl₂ with 4.8 ml cocatalyst MAO (methylaluminoxane) that stored in a tube is injected into the Parr reactor by 377 psia of Argon gas to initiate the copolymerizing reaction with low speed of stirring. The initial temperature of the copolymerizing reaction is kept at about 44° C. and the targeted reaction temperature is maintained at about 70° C. for 60 minutes.

### Comparative Example 2

### CE2

Preparing a 300 ml Parr reactor and is cleaned by using methyl alcohol. The reactor is closed tightly and heated to about 130° C. by a heater under vacuum for about 30 minutes and then the vacuum and heater are removed. 30 psi of propylene gas is then introduced in the reactor. The pressure of the Parr reactor is released until the pressure reaches about 20 psi, then 7 ml TIBA and 4.5 g of 10-undecen-1-ol are added into the Parr reactor separately. 27 g liquid propylene that stored in a bomb reservoir is injected into the Parr reactor with low speed of stirring. 1 mg of metallocene catalyst Rac-Me₂Si[2-Me-4-Ph(Ind)]₂ZrCl₂ and 4.0 ml cocatalyst MAO are introduced into a pipe by Argon gas (pressure 520 psi). The catalyst solution was pushed into the Parr reactor by high pressure Argon gas to start the copolymerizing reaction. The initial temperature of the copolymerizing reaction is at about 45° C. and the targeted reaction temperature is maintained at about 70° C. for 60 mins.

### Comparative Example 3

### CE3

Preparing a 300 ml Parr reactor and it is cleaned by methyl alcohol. The reactor is closed tightly and heated to about 130° C. by a heater under vacuum for about 30 minutes and then the vacuum and heater are removed. A 30 psi of propylene gas is introduced into the reactor. The pressure of the Parr reactor is then released until its pressure reaches about 20 psi, then 7 ml TIBA and 11.24 g of undecenyloxy-trimethylsilane produced by preparation 1 are added into the Parr reactor separately. 75 g liquid propylene that stored in a bomb reservoir is injected into the Parr reactor with low speed of stirring. 1 mg of metallocene catalyst Rac-Me₂Si[2-Me-4-Ph(Ind)]₂ZrCl₂ and 2.0 ml cocatalyst MAO are introduced into the reactor by Argon gas (pressure 520 psi) to start the copolymerizing reaction. The initial temperature of the copolymerizing reaction is kept at about 45° C. and the targeted reaction temperature is maintained at about 70° C. for 60 mins. Then, HCl is added to hydrolyze the copolymer to form hydroxyl functional group by substituting the proton for the trimethylsilane group.

### Comparative Example 4

### CE4

Preparing a 300 ml Parr reactor and is cleaned with methyl alcohol. The reactor is closed tightly and heated to about 130° C. by heater with vacuum for about 30 minutes and then the vacuum and heater are removed. A 30 psi of propylene gas is introduced into the reactor. The pressure of the Parr reactor is then released until its pressure reaches about 20 psi, then 4.5 ml TIBA and 4.34 g of undecenyloxy-trimethylsilane produced by preparation 1 are added into the Parr reactor separately. 27 g liquid propylene that stored in a bomb reservoir is injected into the Parr reactor with low speed of stirring. 0.75 mg of metallocene catalyst Rac-Me₂Si[2-Me-4-Ph(Ind)]₂ZrCl₂ and 4.5 ml cocatalyst MAO are introduced into the reactor by Argon gas (pressure 520 psi) to start the copolymerizing reaction. The initial temperature of the copolymerizing reaction is kept at about 45° C. and the target reaction temperature is maintained at about 70° C. for 60 mins. Then, HCl is added to hydrolyze the copolymer to form hydroxyl functional group by substituting the proton for the trimethylsilane group.

The following table lists the results of examples 1 to 2 and comparative examples 1 to 4. In the table, the [Zr] represents metallocene catalyst and the [Al] represents TIBA except E1 represents TEA. From CE1, only liquid propylene participates the polymerization reaction and its activity is 28800 without any hydroxyl group produced. From CE2, liquid propylene copolymerizing with 10-undecen-1-ol performs hydroxyl group ratio 5.02%, but the activity is only 4900. From CE3 and CE4 for different [MAO]/[Zr] and [Al]/[comonomer] ratios, liquid propylene copolymerizing with undecenyloxy-trimethylsilane performs hydroxyl group ratio of 2.86% and 3.66%, respectively, but the activity is not high enough, which represents 1200 and 867, respectively. From E1 and E2 for different [MAO]/[Zr] and [Al]/[comonomer] ratios, liquid propylene copolymerizing with undecenyloxy-t-butyldimethylsilane performs OH ratio 1.22% and 2.48% respectively. Meanwhile, the activity is quiet high, which represents 26200 and 22580, respectively. Comonomer and propylene conversion ratios are quiet high in E1 and E2 as well. Due to the high activity and OH ratio, the paint blended with the polyolefin polymer with hydroxyl functional group may perform good affinity with other substance. It is also worth to manufacture the high quality polyolefin polymer by carrying out the polymerization with high activity.

| | | | | | | | activity | |
|---|---|---|---|---|---|---|---|---|
| | | | | Initial | | PP | (g/g | |
| | | [MAO]/[Zr] | [Al]/[comonomer] | Comonomer/Propylene | Comonomer | Cov. | cata. | OH |
| Sample | Comonomer | mol/mol | mol/mol | mole ratio | Cov. Ratio | Ratio | hr) | ratio |
| E1 | undecenyloxy t- | 6573 | 4.26 | 0.7% | 67.1% | 46.8% | 26200 | 1.22% |
| | butyldimethylsilane | | | | | | | |
| E2 | undecenyloxy t- | 3287 | 1.07 | 2.9% | 61.2% | 83.6% | 22580 | 2.48% |
| | butyldimethylsilane | | | | | | | |
| CE1 | none | 3005 | 0.00 | 0.0% | 0.0% | 68.6% | 28800 | 0.00% |
| CE2 | 10 undecen-1-ol | 3756 | 1.04 | 4.1% | 31.3% | 18.1% | 4900 | 5.02% |
| CE3 | undecenyloxy- | 1848 | 0.60 | 2.6% | 0.9% | 0.8% | 1200 | 2.86% |
| | trimethylsilane | | | | | | | |
| CE4 | undecenyloxy- | 5634 | 0.99 | 2.8% | 3.2% | 2.4% | 867 | 3.66% |
| | trimethylsilane | | | | | | | |

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method to fabricate polyolefin polymer with hydroxyl functional group, comprising steps of:
1) blending a polar solvent, an α,ω-alkyenol compound and a trialkyl halosilane compound to form a trialkyl-siloxane group protected co-monomer;
2) copolymerizing the trialkyl-siloxane group protected co-monomer with an α-olefin monomer to form a copolymer with side chain trialkyl-siloxane group protectors in presence of a metallocene catalyst and co-catalyst mixture; and
3) hydrolyzing the copolymer with the side chain trialkyl-siloxane group protectors with an acid to form the polyolefin polymer with at least one hydroxyl functional group.

2. The method to fabricate the polyolefin polymer with hydroxyl functional group according to claim 1, wherein the α,ω-alkyenol compound is represented by formula [I]:
CH₂═CH-L-OH [I],
wherein L is alkyl comprising a carbon number from about 1 to about 20.

3. The method to fabricate the polyolefin polymer with hydroxyl functional group according to claim 2, wherein L is (CH₂)ₚ and p is an integer between about 1 and about 20.

4. The method to fabricate the polyolefin polymer with hydroxyl functional group according to claim 3, wherein p is an integer between about 5 and about 11.

5. The method to fabricate the polyolefin polymer with hydroxyl functional group according to claim 1, wherein the trialkyl halosilane compound is represented by formula [III]: 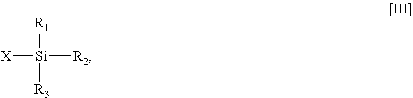
wherein each of the R₁, R₂ and R₃ is the same or different alkyl group comprising a carbon number from about 1 to about 20, X is selected from the group consisting of fluorine, chlorine, bromine, iodine and a combination thereof.

6. The method to fabricate the polyolefin polymer with hydroxyl functional group according to claim 5, wherein one of the R₁, R₂ and R₃ is alkyl group comprising a carbon number greater than 2, and two of the R₁, R₂ and R₃ are methyl groups.

7. The method to fabricate the polyolefin polymer with hydroxyl functional group according to claim 1, wherein the trialkyl halosilane compound is selected from the group consisting of a tert-butyldimethylchlorosilane, an iso-butyldimethylchlorosilane, a n-butyldimethylchlorosilane and a combination thereof.

8. The method to fabricate the polyolefin polymer with hydroxyl functional group according to claim 1, wherein the α-olefin monomer comprises about 3 to about 12 carbon atoms.

9. The method to fabricate the polyolefin polymer with hydroxyl functional group according to claim 1, wherein a trialkylaluminum compound represented by formula [XI] is further added to step 2) for the copolymerizing: 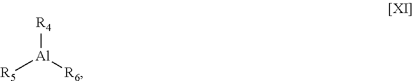
wherein each of R₄, R₅ and R₆ is the same or different alkyl group comprising about 1 to about 20 carbon atoms.

10. The method to fabricate the polyolefin polymer with hydroxyl functional group according to claim 1, wherein ethylene is further added to step 2) to react with the α-olefin monomer and the trialkyl-siloxane group protected co-monomer for the copolymerizing.

11. The method to fabricate the polyolefin polymer with hydroxyl functional group according to claim 10, wherein the copolymer with side chain trialkyl-siloxane group protectors is represented by formula [VIII]: 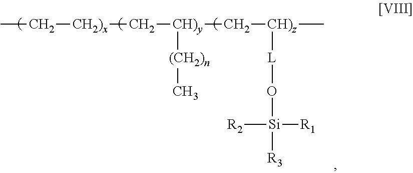
wherein L is as defined in claim 2, R₁, R₂ and R₃ are as defined in claim 5, and n is an integer between 0 and about 9, and set total number x+y+z=sum, the mole % of ethylene-derived units in the copolymer, x/sum, is between 0% and about 20%, the mole % of α-olefin units in the copolymer, y/sum, is between about 50% and about 99.9%, and the mole % of hydroxyl functional group derived units in the copolymer, z/sum, is between about 0.1% and about 30%.

12. The method to fabricate the polyolefin polymer with hydroxyl functional group according to claim 1, wherein the copolymerizing is carried out in a temperature range from about 35° C. to about 100° C. and a pressure range from about 1 psi to about 1000 psi.

13. The method to fabricate the polyolefin polymer with hydroxyl functional group according to claim 1, wherein the α-olefin monomer is in the form of liquid phase.

14. The method to fabricate the polyolefin polymer with hydroxyl functional group according to claim 1, wherein ethylene is further added to step 2) to react with the α-olefin monomer and the trialkyl-siloxane group protected co-monomer for the copolymerizing and the polyolefin polymer is represented by formula [XII]: 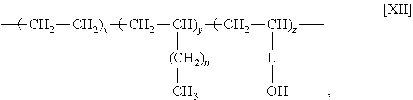
wherein L is as defined in claim 2, and n, x, y, and z are as defined in claim 11.

15. The method to fabricate the polyolefin polymer with hydroxyl functional group according to claim 1, wherein the hydroxyl functional group molar percent of the polyolefin polymer with hydroxyl functional group is between about 0.1% and about 30%.

16. The method to fabricate the polyolefin polymer with hydroxyl functional group according to claim 1, wherein the average molecular weight of the polyolefin polymer with hydroxyl functional group is from about 10,000 to about 5,000,000.

17. A method to fabricate polyolefin polymer with hydroxyl functional group, comprising steps of:
1) blending a polar solvent, an α,ω-alkyenol compound and a dialkyl dihalosilane compound to form a dialkyl-siloxane group protected co-monomer;
2) copolymerizing the dialkyl-siloxane group protected co-monomer with an α-olefin monomer to form a copolymer with side chain dialkyl-siloxane group protectors in presence of a metallocene catalyst and co-catalyst mixture; and
3) hydrolyzing the copolymer with side chain dialkyl-siloxane group protectors with an acid to form the polyolefin polymer with hydroxyl functional group.

18. The method to fabricate the polyolefin polymer with hydroxyl functional group according to claim 17, wherein the α,ω-alkyenol compound is represented by formula [I]:
CH₂═CH-L-OH [I],
wherein L is alkyl comprising a carbon number from about 1 to about 20, and the dialkyl dihalosilane compound is represented by formula [IV]: 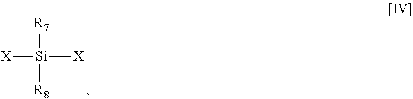
wherein each of the R₇ and R₈ is the same or different alkyl group comprising a carbon number from about 1 to about 20, and X is selected from the group consisting of fluorine, chlorine, bromine, iodine and a combination thereof.

19. The method to fabricate the polyolefin polymer with hydroxyl functional group according to claim 17, wherein ethylene is further added to step 2) to react with the α-olefin monomer and the trialkyl-siloxane group protected co-monomer for the copolymerizing and the polyolefin polymer is represented by formula [XII]: 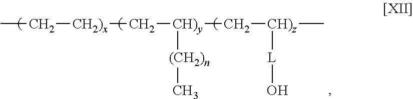
wherein L is as defined in claim 18, and n is an integer between 0 and about 9, and set total number x+y+z=sum, the mole % of ethylene-derived units in the copolymer, x/sum, is between 0% and about 20%, the mole % of α-olefin units in the copolymer, y/sum, is between about 50% and about 99.9%, and the mole % of hydroxyl functional group derived units in the copolymer, z/sum, is between about 0.1% and about 30%.

20. The method to fabricate the polyolefin polymer with hydroxyl functional group according to claim 17, wherein ethylene is further added to step 2) to react with the α-olefin monomer and the trialkyl-siloxane group protected co-monomer for the copolymerizing and the copolymer with side chain dialkyl-siloxane group protectors is represented by formula [IX]: 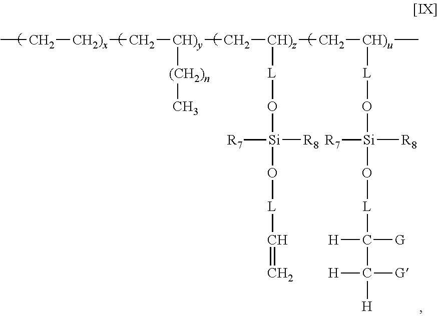
wherein L and each of the R₇ and R₈ are as defined in claim 18, n is an integer between 0 and about 9, and G and G′, independently, are selected from the group consisting of H and polymer chain,
wherein first set total number x+y+z+u=sum, the mole % of ethylene-derived units in the copolymer is defined as x/sum, which is between 0% and about 20%, the mole % of α-olefin units in the copolymer is defined as y/sum, which is between about 50% and about 99.9%, the mole % of hydroxyl functional group derived units in the copolymer is defined as (z+u)/sum, which is between about 0.1% and about 30%, wherein the hydroxyl functional group molar percentage of the polyolefin polymer with hydroxyl functional group is between about 0.1% and about 30%.
